(19) United States
(12) Patent Application Publication
(10) Pub. No.: US 2012/0104999 A1
(43) Pub. Date: May 3, 2012

(54) Multiple Coil System

(75) Inventors: Ross Teggatz, McKinney, TX (US); Wayne Chen, Plano, TX (US); Amer Atrash, Richardson, TX (US)

(73) Assignee: TRIUNE IP LLC, Richardson, TX (US)

(21) Appl. No.: 13/278,088

(22) Filed: Oct. 20, 2011

Related U.S. Application Data
(60) Provisional application No. 61/409,325, filed on Nov. 2, 2010.

(51) Int. Cl. H02J 7/00; H01F 27/28

(52) U.S. Cl. 320/108; 336/220; 336/200

(57) ABSTRACT

Multiple coil systems and methods are disclosed in which transmitter and receiver inductors, or coils, are coupled in a configuration for wirelessly transferring data and/or power among them. In preferred implementations, the systems and methods are used for transmitting both power and data using pairs of coupled coils. One preferred aspect of the invention is that the coils are not permanently affixed in physical proximity to one another, but can be moved and/or interchanged.

### PRIORITY ENTITLEMENT

This application is entitled to priority based on Provisional Patent Application Ser. No. 61/409,325 filed on Oct. 20, 2010, which is incorporated herein for all purposes by this reference. This application and the Provisional Patent Application have at least one common inventor.

### TECHNICAL FIELD

The invention relates to coupled inductor coil systems. More particularly, the invention relates to multiple coil systems for use in wireless power and data transfer applications. In preferred embodiments of multiple coil systems employed in wireless power applications, the invention relates to the more efficient utilization of energy resources.

### BACKGROUND OF THE INVENTION

It is known to use coupled inductors to facilitate wireless data transfer. Wireless power transmission can also be accomplished using coupled inductors. Several challenges arise in using coupled inductors for sending and receiving data in the presence of active inductive power transmission. Among them, maintaining data integrity and bandwidth are of concern. Further concerns relating to coupled inductors or coils used for wireless chargers and/or wireless data implementations include system performance, efficiency, flexibility, form factors suitable for use with existing technology, and costs. The proper implementation can dramatically improve the usefulness of an overall system, which may include wireless data systems, wireless power systems, and/or systems in which data and power are wirelessly exchanged among coupled coils.

Due to these and other problems and potential problems, improved coupled inductor power and data transmission systems would be useful and advantageous contributions to the arts.

### SUMMARY OF THE INVENTION

In carrying out the principles of the present invention, in accordance with preferred embodiments, the invention provides advances in the arts with novel methods and apparatus directed to the transfer of data and/or power using inductive couplings. In preferred embodiments, systems include capabilities for unidirectional and bidirectional data and/or power transfer. Preferably, the coupled coils of systems of the invention are not permanently physically interconnected.

According to aspects of the invention, examples of preferred embodiments include multiple coil systems include at least a first coil and a second coil for coupling with the first coil. The first and second coils are preferably not permanently physically affixed to one another and are interchangeable, e.g., a second coil can preferably be removed and replaced with a different second coil. When positioned in proximity, the first and second coils are electromagnetically, but not physically, coupled such that one or more signals may be passed between the coils.

According to additional aspects of the invention, in examples of preferred embodiments, a system for coupling two or more coils according to the descriptions herein also includes a wireless power control mechanism associated with one or more of the coils.

According to more aspects of the invention, preferred embodiments also include circuitry suitable for the transmittal and/or receipt of data.

According to another aspect of the invention, preferred multiple coil coupling systems in preferred embodiments are adapted for transmitting and receiving both power and data.

According to an additional aspect of the invention, an example of a preferred system of the invention is embodied in the form of battery charging apparatus.

The invention has advantages including but not limited to one or more of, improved coupled coil system form factors, improved power transfer, improved bandwidth, improved data integrity, and reduced costs. These and other potential advantageous, features, and benefits of the present invention can be understood by one skilled in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a simplified perspective view illustrating an example of a preferred embodiment of a multiple coil system according to the invention;

FIG. 2 is a simplified perspective view of another example of a preferred embodiment of a multiple coil system according to the invention;

FIG. 3 is a simplified schematic top view illustrating an example of a preferred embodiment of a coplanar multiple coil system according to the invention;

FIG. 4 is a simplified schematic close-up top view illustrating an example of an interleaved coil portion of preferred embodiments of multiple coil systems according to the invention;

FIGS. 5A and 5B are simplified perspective views illustrating examples of preferred embodiments of multiple coil systems for wireless power transmission according to the invention;

FIG. 6 is a diagram illustrating an example of a coil for use in implementing preferred embodiments of multiple coil systems according to the invention; and

FIG. 7 is a diagram illustrating another example of a preferred embodiment of a multiple coil system according to the invention.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as anticipated and unanticipated advantages of the invention.

### DESCRIPTION OF PREFERRED EMBODIMENTS

The present patent application is related to U.S. patent application Ser. No. 13/045,493 which shares at least one common inventor with the present application and has a common assignee. Said related application is hereby incorporated herein for all purposes by this reference.

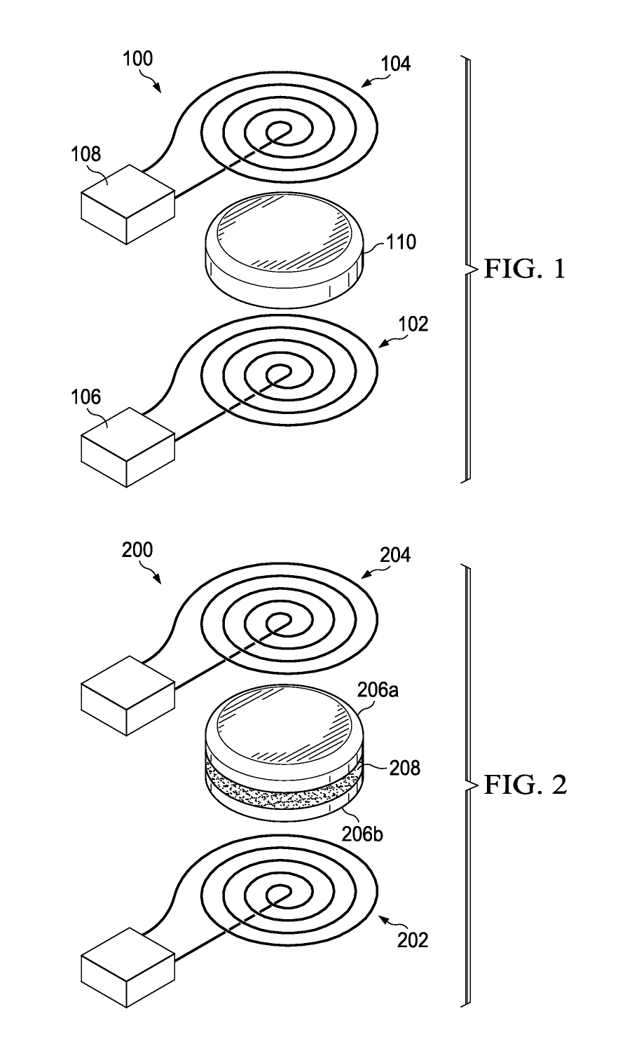

It has been determined that high inductance coils (e.g., micro-Henries) switched at low frequencies (e.g., hundreds of kHz) are effective for power transfer in applications such as battery chargers and power converters, for example. It has also been learned that data may be transferred efficiently among coupled coils. Referring initially to the illustration shown in FIG. 1, an example of a preferred embodiment of a multiple coil system 100 is shown in which a first coil 102 is positioned in proximity to a second coil 104. The first and second coils 102, 104 are oriented and positioned so that they may be electromagnetically coupled in order to facilitate a transfer of energy between them. Preferably, the coils are not permanently physically connected with one another. Each of the coils may be connected with additional circuitry, not necessarily part of the invention, designed for particular functionality. For example, the first coil 102 may be associated with power or data signal transmitting circuitry, and the second coil 104 may be associated with a battery and corresponding power or data receiving circuitry, or vice versa. It should also be appreciated that the respective coils preferably reside in electronic apparatus or systems of various kinds. For example, the first coil 102 may reside within a battery charger or power inverter apparatus, and the second coil 104 may reside in a battery for a communication, computer, imaging or other device, to cite a few examples. The respective coils 102, 104, are positioned within their respective apparatus such that, in operation, they may be placed in physical proximity for inductive coupling during such that the coils are in communication with one another for the exchange of power and/or data. The system 100 drives the first coil(s), e.g., 102 on one side to transmit, and receives at the second coil(s), e.g., 104, on the other side. Such systems can be utilized for high bandwidth communication as well as power transfer across the inductive coupling between the first and second coils 102, 104. For example, communication equipment suitable for data transfer among coils is shown at reference numerals 106 and 108, representing data transmission and receiving apparatus respectively. Transmitter, receiver, or transceiver apparatus may be used as desired for the particular implementation, using available communications equipment in combination with the coil system 100. Preferably, an isolation barrier 110 of dielectric material is interposed between the first and second coils 102, 104. The isolation barrier 110 isolates the coils from one another electrically, but preferably does not substantially impede the inductive coupling between them.

There are advantages to utilizing inductive multiple coil data and power transmission simultaneously. In a system which transmits both power and data, the power loop can be regulated using communication through the inductive data path. This path has higher bandwidth than other communication techniques such as modulating the power signal. Providing a high speed data path also enables additional functionality. Using the high speed data path for power control permits higher bandwidth in the power system and faster response times.

As shown in FIG. 2, a system 200 may include first 202 and second coils 204 as described with reference to FIG. 1, and also include a ferrous material 208 interposed between the coils 202, 204, which by its magnetic properties acts to enhance inductive coupling. Preferably, the ferrous material 208 is insulated from the coils 202, 204 by suitable isolation barriers, as shown at 206a and 206b. It can be seen in the examples depicted in FIGS. 1 and 2 that the coils may be substantially planar. In each of these exemplary preferred embodiments, two substantially planar coils are used in an opposing orientation.

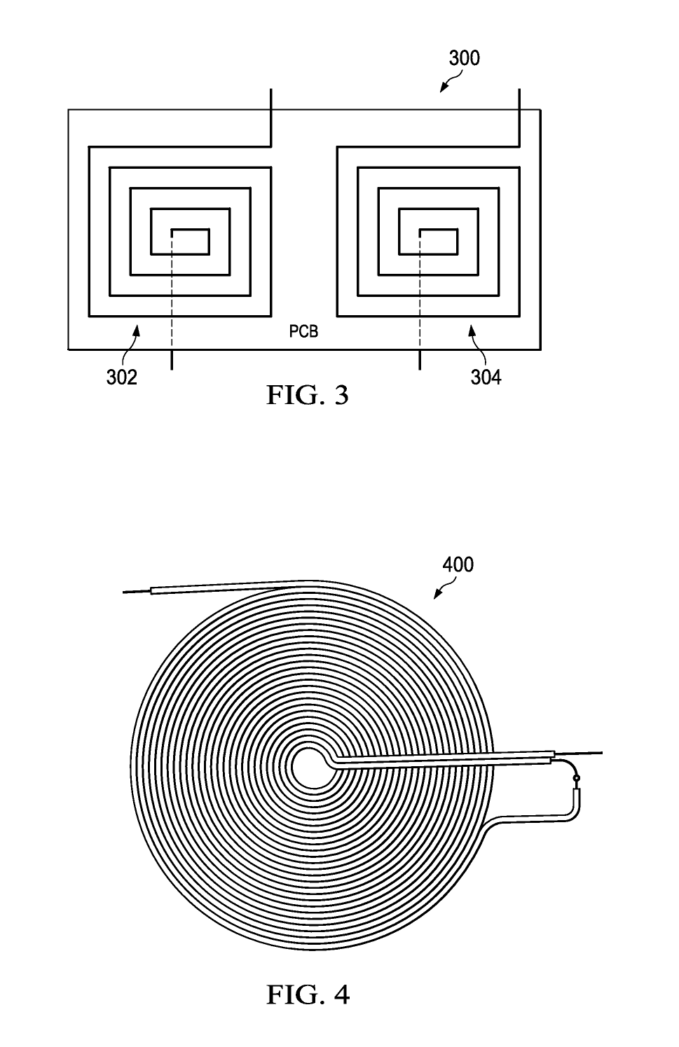

Now referring to FIG. 3, an alternative embodiment of a system 300 illustrates that first and second coils 302, 304 may be positioned in a coplanar arrangement. In this example, the planar coils 302, 304 are positioned such that they align in sufficiently close proximity to facilitate inductive coupling between them. It should be appreciated that for systems using one or more substantially planar coils, the planar coils themselves may be integrated into a leadframe, PCB, IC, or other structure. Of course, various combinations of structures incorporating integrated or discrete planar coils may be used. Additionally, isolation barriers as described above may also be used in various combinations to electrically isolate coils and/or to enhance their inductance.

In another example of preferred embodiments of multiple coil systems as described, interleaved coils, such as interleaved first and second coils, may be configured as shown in FIG. 4. Such interleaved coils 400 may be arranged, for example, in place of singular coils as shown the manner described with reference to FIGS. 1 through 3, above.

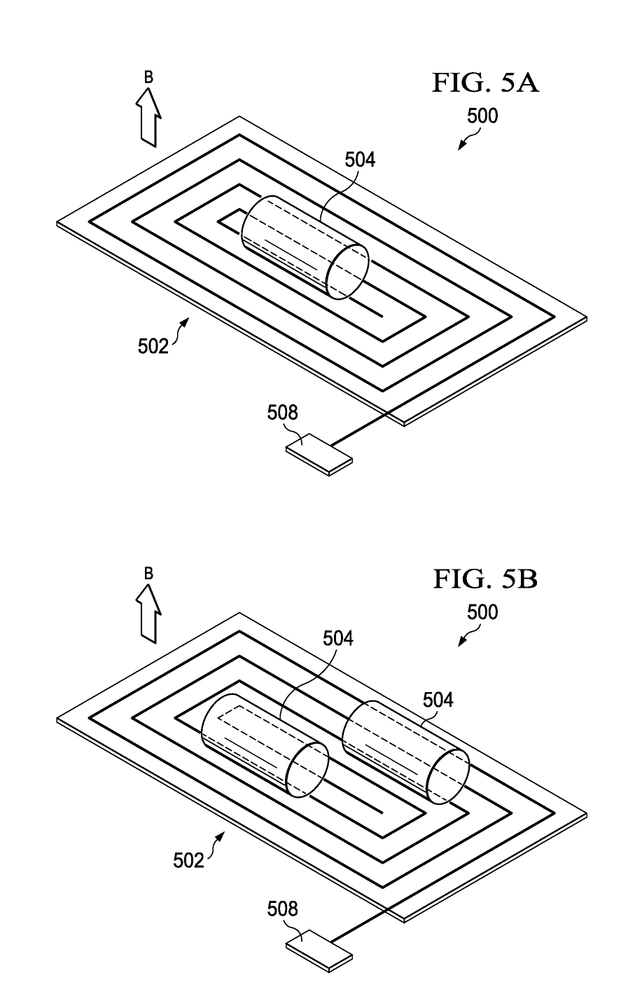

As portrayed in FIG. 5A, the invention may also be embodied in a system 500 wherein one or more of the coils is cylindrical. In this exemplary embodiment, a first coil 502 is substantially planar. A second coil 504 is wrapped around a cylindrical object, for example a battery. In this configuration, the first coil 502 is preferably adapted to transmit power in a direction perpendicular to the windings of the first coil 502 as indicated by the arrow “B”. The second coil 504 preferably receives the transmitted power, e.g., for storage in the battery. In some embodiments, as shown in FIG. 5B, it may be preferable to deploy multiple second coils 504, in order to charge two batteries for example. This is accomplished by providing duplicate second coils 504 for deployment on the first coil 502 for receiving power. Preferably, a wireless power control mechanism 508 is provided in association with the first coil 502. The wireless power control mechanism 508 is adapted to detect the presence of the second coils 502A, 502B, and to alternatively select one of the second coils for receiving power. In this way, a number of batteries or other devices equipped with second coils may be charged sequentially using the first coil. Wireless power control mechanisms may similarly, or alternatively, be provided in association with the second coils.

Referring primarily to FIG. 6, in alternative embodiment as represented in the example shown, the second coil(s) 604 of the system may be configured in the form of a cylinder segment. In this example a semicylindrical configuration is illustrated. Greater or lesser cylinder segments may also be used without departure from the principles of the invention.

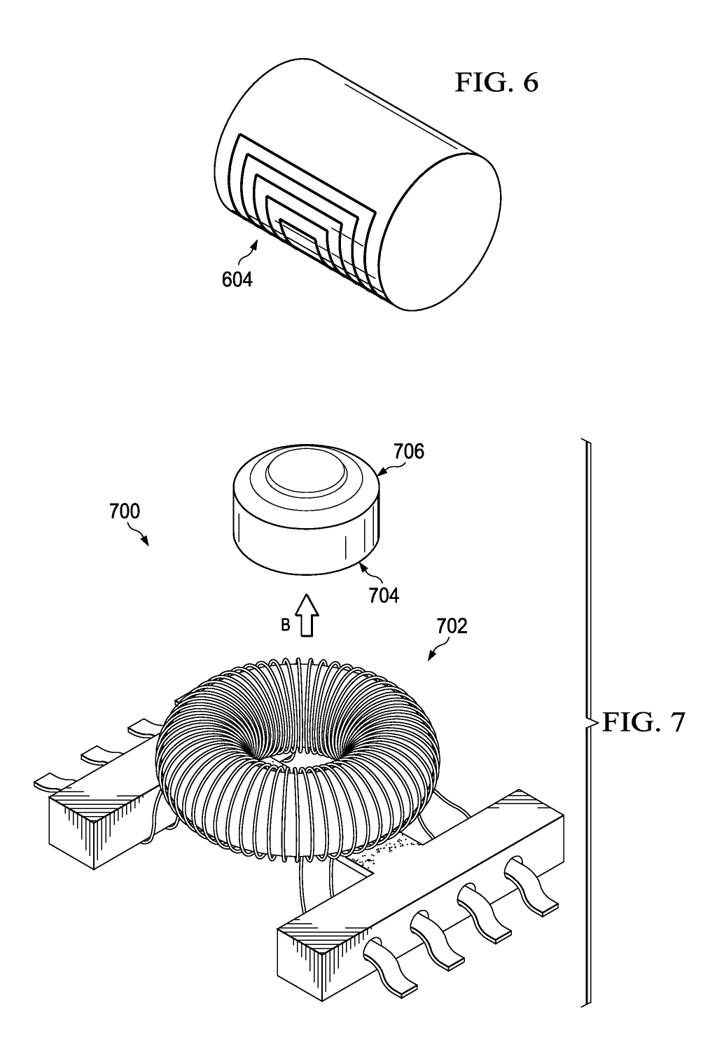

FIG. 7 shows an example of an alternative embodiment of a multiple coil system 700 in which a first coil 702 is implemented in the form of a toroid. The direction of the magnetic field of the first coil 702 is indicated by arrow B. A second coil 704, for example integrated with a battery 706, is preferably placed in proximity to the first coil 702 for charging.

While the making and using of various exemplary embodiments of the invention are discussed herein, it should be appreciated that the present invention provides inventive concepts which can be embodied in a wide variety of specific contexts. It should be understood that the invention may be practiced with coupled inductor systems having communications and power transfer functionality, such as in battery chargers and AC/DC converters. For purposes of clarity, detailed descriptions of functions, components, and systems familiar to those skilled in the applicable arts are not included. The methods and apparatus of the invention provide one or more advantages including but not limited to, data transfer capabilities, managed power transfer capabilities, and enhanced energy utilization and conservation attributes. While the invention has been described with reference to certain illustrative embodiments, those described herein are not intended to be construed in a limiting sense. For example, variations or combinations of steps or materials in the embodiments shown and described may be used in particular cases without departure from the invention. Various modifications and combinations of the illustrative embodiments as well as other advantages and embodiments of the invention will be apparent to persons skilled in the arts upon reference to the drawings, description, and claims.

We claim:

1. A system for coupling two or more coils comprising:
a first coil; and
a second coil for removably coupling with the first coil;
whereby an electromagnetic signal may be passed between the coils.

2. The system for coupling two or more coils according to claim 1 further comprising an isolation barrier interposed between the first and second coils;

3. The system for coupling two or more coils according to claim 1 further comprising ferrous material interposed between the coils to enhance coupling.

4. The system for coupling two or more coils according to claim 1 further comprising a wireless power control mechanism associated with one or more coil.

5. The system for coupling two or more coils according to claim 1 wherein at least two of the coils are interleaved.

6. The system for coupling two or more coils according to claim 1 wherein at least one coil is integrated into a leadframe.

7. The system for coupling two or more coils according to claim 1 wherein at least one coil is printed on a PCB.

8. The system for coupling two or more coils according to claim 1 wherein at least one of the coils is substantially planar.

9. The system for coupling two or more coils according to claim 1 wherein at least two of the coils are coplanar.

10. The system for coupling two or more coils according to claim 1 wherein at least one coil comprises a cylinder.

11. The system for coupling two or more coils according to claim 1 wherein at least one coil comprises a semicylinder.

12. The system for coupling two or more coils according to claim 1 wherein at least one coil comprises a cylinder segment.

13. The system for coupling two or more coils according to claim 1 wherein at least one coil comprises a toroid.

14. The system for coupling two or more coils according to claim 1 wherein at least one coil further comprises data receiving circuitry.

15. The system for coupling two or more coils according to claim 1 wherein at least one coil further comprises data transmittal circuitry.

16. The system for coupling two or more coils according to claim 1 wherein at least one coil further comprises power receiving circuitry.

17. The system for coupling two or more coils according to claim 1 wherein at least one coil further comprises power transmittal circuitry.

18. The system for coupling two or more coils according to claim 1 wherein first and second coils are deployed on a charger circuit and battery respectively.

19. A battery charger system comprising:
a first coil operably connected to a charger circuit; and
a second coil for removably coupling with the first coil, the second coil operably connected with a battery;
whereby an electromagnetic signal may be passed from the first coil to the second coil, charging the battery.

20. The system according to claim 19 further comprising a wireless power control mechanism associated with one or more coil.
